(19) United States
(12) Patent Application Publication
(10) Pub. No.: US 2010/0081414 A1
(43) Pub. Date: Apr. 1, 2010

(54) BACKUP PIN ENTRY USING CAMERA AND OCR

(76) Inventor: David Poisner, Carmichael, CA (US)

Correspondence Address: INTEL CORPORATION;c/o CPA Global, P.O. BOX 52050, MINNEAPOLIS, MN, 55402, US

(21) Appl. No.: 12/242,718

(22) Filed: Sep. 30, 2008

(51) Int. Cl. H04M 1/66

(52) U.S. Cl. 455/411

(57) ABSTRACT

A personal identification number (PIN) may be used as a basic security measure to unlock an electronic device. PINs are notoriously forgotten or unavailable. A master security code may be used to unlock the device in this situation. The master security code may comprise printed indicia such as an alpha-numeric text string, for example, printed in the device owner's manual. A picture or image of the page containing the master security code may be snapped with a built-in camera feature. Optical character recognition (OCR) may be used to extract the master security code text string from the image and compared to a like master security code stored in the device. If they match, the device may be unlocked even without the PIN.

### FIELD OF THE INVENTION

Embodiments of the present invention are directed electronic device security and, more particularly, to unlocking an electronic device if the password is forgotten or unknown.

### BACKGROUND INFORMATION

Wireless devices, such as cellular telephones, and Personal Digital Assistants (PDA) communicators are gaining widespread acceptance. In order to be competitive in the marketplace and to meet consumer demand, service providers continue to offer an ever expanding array of services and features. Current generations of PDAs incorporate many features including cellular phone service.

PDAs are hand-held computers originally designed for use as personal organizers for storing notes, contact information, calendar dates and so forth. The current generation of PDAs additionally incorporate wireless and cellular technology and act as a phone for voice communications as well as allows users to access a variety of information and include services and features such as internet browsing, access to driving directions, instant stock quotes, global positioning system (GPS) capabilities, entertainment locators, email service, cameras, and a variety of multimedia and video capabilities, to name a few.

Many of these hand-held devices also incorporate a certain level of security to protect against unwanted users as well as to protect the privacy of the personal data stored therein. One of the most common and well known security measures is a password or personal identification number (PIN). In a locked mode, an authorized user must enter the PIN to unlock the device and enable the features. However, if the PIN is forgotten or lost, even the owner or other authorized user cannot use the device.

### BRIEF DESCRIPTION OF THE DRAWINGS

The foregoing and a better understanding of the present invention may become apparent from the following detailed description of arrangements and example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only and the invention is not limited thereto.

FIG. 1 is a hand held device including a camera feature according to one embodiment of the invention; and

FIG. 2 is a block diagram of the basic components of the of the hand held device.

### DETAILED DESCRIPTION

Described is an apparatus and method to allow an authorized user to override the security features of an electronic device with a master code. Security is maintained, however, since only an authorized user may have physical access to the master code.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As discussed above, hand held PDAs for general purpose communication and data storage are popular. More recently, specific purpose portable devices have been developed. In particular, in the healthcare field a hand held device may provide a variety of functions, including a device for the sight impaired which can read text aloud. In short, the device uses a built-in camera to take pictures of text, perform an optical character recognition (OCR) on the text, and then uses text-speech synthesis to read it out loud to the user. This device is not only advantageous for the sight impaired, but also for the elderly which may have trouble reading smaller texts.

In addition, a user may have private information stored on the device. Such private information may include such things as scans of credit card receipts, tax forms, medical records, or business transactions. The device includes a PIN-based method to protect access to the user's data files. If the correct PIN is not entered, the system prevents the reading, deletion, modification, or renaming of the user's files.

There are some cases where the user may forget the PIN, or the user is no longer available to enter the PIN, such as if they die or leave employment, in the case where the device is owned by an employer.

In some systems, the PIN can be bypassed by having a secondary PIN. This secondary PIN might be something other than a password, such as a series of questions that contain information that presumably would only be known to the user. For example, this might include questions about favorite colors, school mascots, parents, etc.

However, entry of these types of questions may be difficult since the device may not have a traditional keyboard. Furthermore, these types of schemes are inherently poor in the long term because the private information may be needed for multiple systems, and compromise of one could result in compromise of other systems.

Embodiments of the present invention provide a system to unlock or override the PIN security with a master security code or key using the natural interface and capabilities of the device without actually manually entering a code. Embodiments may comprise a wide array of electronic devices including cell phones, Ultra Mobile Devices, or PDAs that are equipped with a camera.

Referring now to FIG. 15 there is shown an exemplary electronic device, such as a PDA 100. The device may allow services such as phone for voice communications as well as allows users to access a variety of information and include services and features such as internet browsing, global positioning system (GPS) capabilities, email service, store music and data, etc. Typically, the electronic device 100 is of a size and weight which easily fits in a user's hand. The device 100 may have a display screen 102 with which to display text and graphics. The display screen 102 may also be a touch type display screen allowing the user to input data and commands by touching the screen with their finger or with a stylus (not shown).

A keypad 104 may be included as well to allow the user to input data and commands. The keypad 104 may be a full alpha-numeric keypad or may just comprise one or more special function keys as shown. In the case where the display screen 102 is a touch-type screen, the keypad 104 may optionally be omitted. In addition, a cursor control 106 may also be included to allow a user to perform mouse-type cursor movements.

A camera 108 is also included to allow the electronic device to capture and store images. The camera 108 is shown on the front of the electronic device 100 for purposes of illustration, but the camera 108 may be located anywhere. The device 100 may also include a speaker and microphone such a traditional phone would have as well as speaker-phone capabilities allowing the user to hear and talk without having to hold the device 100 to their head.

As noted above, the device 100 may include a security function that allows the user to optionally select a personal identification code (PIN) of their choice which is used to lock the functions of the device from use as well as lock any data stored therein. The PIN may be an alpha-numeric string of characters chosen at random by the user; preferably something easy to remember but difficult for someone else to figure out. The PIN may be enter in a variety of ways by the user, such as by typing on the display screen 102 or on the keypad 104 or perhaps even by speaking it (out of earshot of others) if the device 100 has speech recognition capabilities.

Unfortunately, often times PINs are forgotten or changed often and the new PIN forgotten, or the authorized user that selected the PIN is no longer available, such as in the case of death or disability or if the PIN is biometric. According to embodiments, the device 100 includes a “master security code” 110 or key which can always unlock the device without need of the current PIN. This master code 110 may be an alpha-numeric string which is sufficiently long and random. In other embodiments, the master code may be symbols or, for example, a bar code. The master code 110 may be specific that that particular device 100 and may be shipped with the device 100 as printed indicia and may be printed, for example, in the owner's manual 112 for the device 100. The manual 112, and thus the master code 110 along with it, may be stored in a safe place apart from the device 100.

In operation, should the PIN be unknown, the user may retrieve the master code 112 from its secure location, and use the camera 108 feature of the device to capture the image of the master code 110. Thereafter, the device 100 may use optical character recognition (OCR) to convert the image into text and compare the converted text to the master code stored in the device. If they match, the device is unlocked and full operation is available to the user. Note, that even when the device is locked, the camera feature remains available for the purpose of this operation.

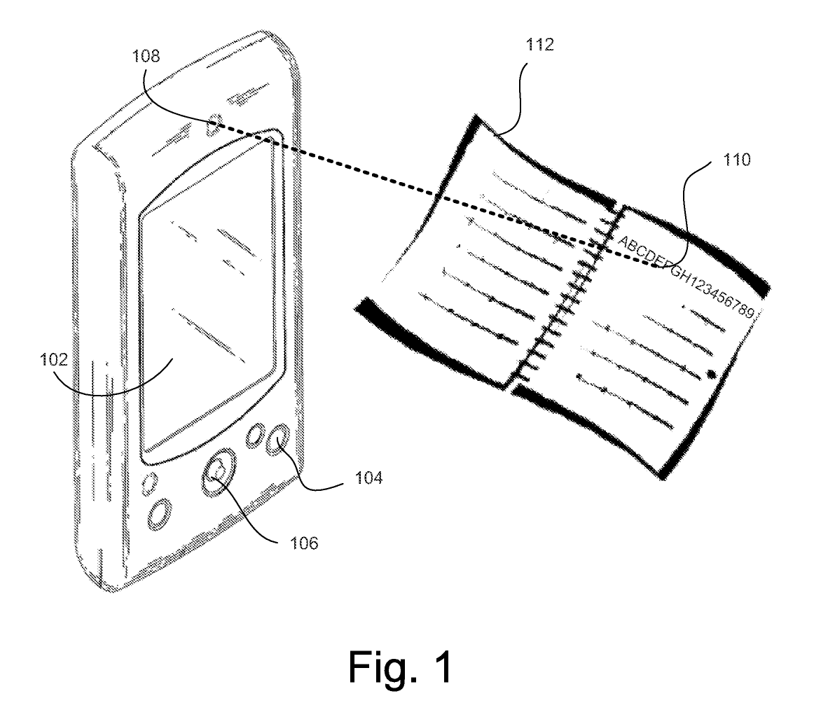

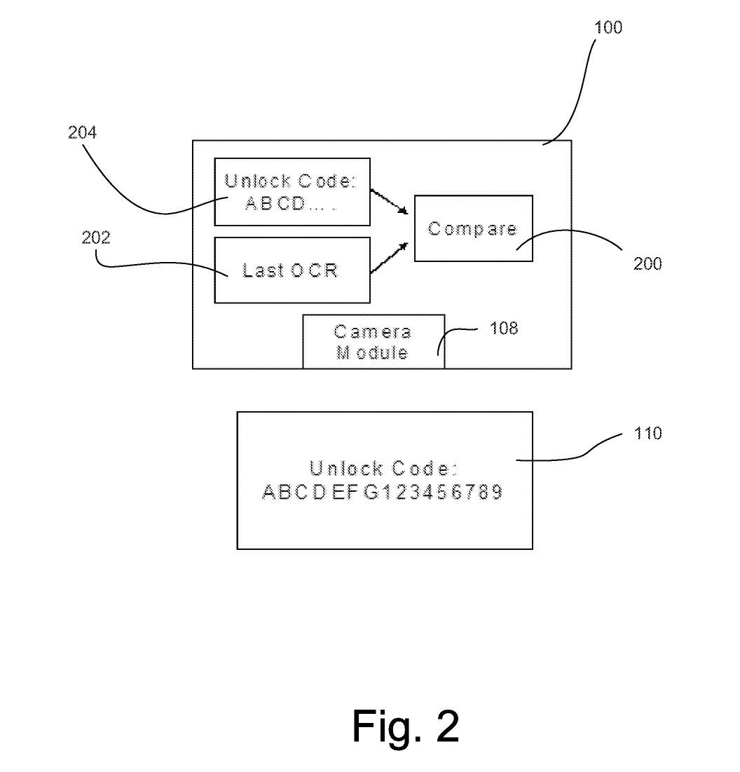

Referring now to FIGS. 1 and 2, there is shown a block diagram of the basic features of the device 100. At the time of shipment, a unique unlock key or master security code 204 is programmed into the device 100. This key should be sufficiently long to make guessing unlikely. For example, this could be a 32-digit alpha-numeric string. This string may also be printed on a piece of paper that is shipped with the device 100. That piece of paper might be the last page of the user manual.

If the device 100 is “locked” via the PIN, and the user doesn't know the pin, the user will instead capture an image of the “unlock” piece of the master security code 110 paper using standard image capture capability with the camera feature 108. The user may then select an “unlock” function which may be a virtual button on the display screen 102 or pressing a selected button on the keypad 104.

When the unlock function is selected, the device 100 will perform an optical character recognition (OCR) operation on the last picture taken. It will then compare with the comparator module 200 the output of the OCR module 202 with a copy of the master security code 204 stored in the device 100. If the string compares, then the system will treat this as the equivalent of the PIN and the device will unlock.

According to embodiments a backup PIN or master security code is stored as a text string that may be extracted using OCR operation. Since many hand held devices already include cameras, there may be no additional hardware cost to implement this type of security. Plus, should the PIN be unavailable, there is no need for the user to remember anything other than where they last placed the unlock paper, which will likely be with the rest of the user documentation and user's manual for the device.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An electronic device, comprising:
a master security code stored in the device;
a camera to capture an image of printed text,
an optical character recognition (OCR) module to extract the text from the captured image; and
a comparator module to compare the text to the master security code, wherein the electronic device is unlocked if the text matches the master security code.

2. The electronic device as recited in claim 1, further comprising:
a touch-type display screen for inputting data.

3. The electronic device as recited in claim 1, wherein the electronic device comprises a personal digital assistant (PDA).

4. The electronic device as recited in claim 1, wherein the electronic device comprises a mobile telephone.

5. The electronic device as recited in claim 1 wherein the electronic device comprises a personal identification number (PIN) security feature that is overridden by the master security code.

6. The electronic device as recited in claim 1, wherein the printed text comprises a paper having a copy of the master security code printed thereon.

7. A method for unlocking a locked electronic device, comprising:
storing a master security code in the device;
taking a picture of a printed master security code with a built-in camera;
extracting an alpha-numeric text string from the picture using optical character recognition (OCR);
comparing the extracted alpha-numeric text string with the master security code stored in the device; and
unlocking the electronic device if there is a match.

8. The method as recited in claim 7, wherein the printed master security code is printed on a piece of paper.

9. The method as recited in claim 8, wherein the paper is included with the user's manual for the electronic device.

10. The method as recited in claim 8, wherein the electronic device comprises a personal digital assistant (PDA).

11. The method as recited in claim 8, wherein the electronic device comprises a mobile telephone.

12. The method as recited in claim 8 wherein the device comprises a device for storing personal data.

13. A system for unlocking a locked electronic device, comprising:
a printed text separate from the electronic device;
a master security code stored in the device;
a camera to capture an image of the printed text;
an optical character recognition (OCR) module to extract the text from the captured image; and
a comparator module to compare the text to the master security code, wherein the electronic device is unlocked if the text matches the master security code.

14. The system as recited in claim 13, further comprising:
a touch-type display screen for inputting data.

15. The system as recited in claim 13, wherein the electronic device comprises a personal digital assistant (PDA).

16. The system as recited in claim 13, wherein the electronic device comprises a mobile telephone.

17. The system as recited in claim 13, wherein the electronic device comprises a personal identification number (PIN) security feature that is overridden by the master security code.

18. The system as recited in claim 13, wherein the printed text comprises a paper having a copy of the master security code printed thereon.

19. The system as recited in claim 18, wherein the paper comprises the user's manual for the electronic device.
